(19) United States
(12) Patent Application Publication
(10) Pub. No.: US 2026/0169157 A1
(43) Pub. Date: Jun. 18, 2026

(54) METHOD OF FUSING HETEROGENEOUS SENSORS AND VEHICLE

(71) Applicants: Hyundai Motor Company, Seoul (KR); Kia Corporation, Seoul (KR)

(72) Inventor: Seong Hwan KIM, Hwaseong-Si (KR)

(21) Appl. No.: 19/398,951

(22) Filed: Nov. 24, 2025

(30) Foreign Application Priority Data
Dec. 13, 2024 (KR) 10-2024-0186195

(51) Int. Cl. G01S 13/931; B60W 60/00; G01S 13/86; G06V 10/764; G06V 10/80; G06V 10/82; G06V 20/58

(52) U.S. Cl. CPC G01S 13/931; B60W 60/001; G01S 13/865; G01S 13/867; G06V 10/803; G06V 20/58; B60W 2554/4042; B60W 2554/4043; B60W 2554/801; B60W 2554/802; B60W 2556/35; G06V 10/764; G06V 10/82

(57) ABSTRACT

Disclosed herein a method of fusing heterogeneous sensors and vehicle. The method includes: generating a first sensor region and a second sensor region based on first sensor data and second sensor data; generating an association region based on characteristic information of any one sensor selected from a first sensor and a second sensor; generating an association information including correlation scores based on first region information and second region information respectively corresponding to the first sensor region and the second sensor region that overlap the association region; and generating a fusion region and fusion information based on the correlation score.

### CROSS-REFERENCE TO RELATED APPLICATION

This application claims the benefit of priority to Korean Patent Application No. 10-2024-0186195, filed in the Korean Intellectual Property Office on Dec. 13, 2024, the disclosure of which is incorporated herein by reference in its entirety.

### TECHNICAL FIELD

The present disclosure relates to a method of fusing heterogeneous sensors and a vehicle, and more specifically, to a method of fusing heterogeneous sensors, of which the accuracy may be increased by reflecting the characteristics of the sensors and the behavior of an object, and a vehicle.

### BACKGROUND

The matters described in this Background section are only for enhancement of understanding of the background of the disclosure, and should not be taken as acknowledgment that they correspond to prior art already known to those skilled in the art.

Vehicles including various functions for driving convenience have been commercialized. To this end, autonomous driving functions are supported in vehicles. The autonomous driving function is being developed so that the vehicle may control driving with minimal or no driver intervention.

The vehicle may recognize the surrounding environment acquired by various types of heterogeneous sensors and identify a situation around the vehicle based on the recognized surrounding environment. The vehicle may establish a control plan for autonomous driving corresponding to the identified situation and control an actuator of the vehicle. Each type of sensor data acquired by each heterogeneous sensor may be aligned and fused for use in a vehicle. Fusion data generated by fusing heterogeneous sensors may provide information about the identity of an identified object. Fusion data estimated to be the same object may be provided in a view in a common space in which heterogeneous sensors are fused or may be used for tracking objects and vehicle control.

An association for fusion of heterogeneous sensors may include calculating association by reflecting only specific parameters of each sensor for a reference sensor adopted among a plurality of sensors that acquire different types of raw data, for example, image data and point cloud data. Here, the association may be generated by calculating a correlation between data of heterogeneous sensors with standardized criteria without reflecting performance characteristics unique to each sensor. An association that does not consider the performance characteristics of the sensor may cause an error in an actual fusion result. In addition, since the correlation may be calculated without considering a movement direction of an object detected by the sensor, such correlation may result in fusion with errors.

### SUMMARY

The present disclosure is directed to providing a method of fusing heterogeneous sensors, of which the accuracy may be increased by reflecting the characteristics of the sensors and the behavior of an object, and a vehicle.

Objects of the present disclosure are not limited to the above-described object, and other objects that are not described will be able to be clearly understood by those skilled in the art to which the present disclosure pertains based on the following description.

According to the present disclosure, a method may be performed by an apparatus of a vehicle. The method may include defining a first sensor region based on first sensor data obtained from a first sensor of the vehicle, and defining a second sensor region based on second sensor data obtained from a second sensor of the vehicle, wherein the first sensor and the second sensor are heterogeneous sensors. The method may further include determining an association region based on characteristic information of at least one sensor of the first sensor or the second sensor, generating association information including a correlation score, wherein the correlation score is determined based on first region information of the first sensor region and second region information of the second sensor region, and wherein the first sensor region and the second sensor region overlap the association region, outputting, based on the association information, a signal indicating a fusion region and fusion information, and controlling, based on the signal, autonomous driving of the vehicle.

For example, the longitudinal data of the object may be generated based on a ratio of a longitudinal velocity of the object to a lateral velocity of the object, and the lateral data of the object may be generated based on a ratio of the lateral velocity of the object to the longitudinal velocity of the object.

For example, the longitudinal data of the object may be configured to be within a longitudinal factor range, and the lateral data of the object may be configured to be within a lateral factor range.

For example, the outputting of the signal indicating the fusion region and the fusion information may include: based on the correlation score satisfying a single fusion condition, generating a single fusion region that represents the first sensor region and the second sensor region as a same object and generating single fusion information about the single fusion region, or based on the correlation score not satisfying the single fusion condition, generating an individual fusion region for each of the first sensor region and the second sensor region and generating individual fusion information for each of the individual fusion regions.

According to the present disclosure, a vehicle may comprise a first sensor and a second sensor that are heterogeneous sensors configured to detect a surrounding environment of the vehicle, and at least one processor circuit configured to define a first sensor region based on first sensor data obtained from the first sensor, and to define a second sensor region based on second sensor data obtained from the second sensor, determine an association region based on characteristic information of at least one sensor of the first sensor or the second sensor, generate association information including a correlation score, wherein the correlation score is determined based on first region information of the first sensor region and second region information of the second sensor region, wherein the first sensor region and the second sensor region overlap the association region, output, based on the association information, a signal indicating a fusion region and fusion information, and control, based on the signal, autonomous driving of the vehicle.

For example, the characteristic information may include an error attribute of at least one sensor, and the association region may be adaptively generated based on the error attribute of the at least one sensor.

The error attribute of the at least one sensor may include at least one of a longitudinal position covariance parameter of the at least one sensor or a lateral position covariance parameter of the at least one sensor. The first region information may include a first position of the first sensor region, and the second region information may include a second position of the second sensor region.

The at least one processor circuit may be configured to determine, based on an error attribute of the second sensor, a distance error of the second position with respect to the first position, and to generate, based on the distance error, the correlation score.

The first region information may further include a first area of the first sensor region, and the second region information may include a second area of the second sensor region. The at least one processor circuit may be configured to generate the correlation score further based on a ratio of an overlapping area of the first sensor region and the second sensor region to a sum of the first area and the second area, and a ratio of the overlapping area to the first area or the second area.

The at least one processor circuit may also be configured to determine the distance error further based on a movement direction of an object, wherein the object is recognized in at least one of the first sensor region and the second sensor region.

For example, the error attribute may include at least one of a longitudinal position covariance parameter of the second sensor and a lateral position covariance parameter of the second sensor. The movement direction of the object may be associated with longitudinal data of the object and lateral data of the object. The at least one processor circuit may be configured to determine the distance error further based on the longitudinal position covariance parameter and the lateral position covariance parameter, wherein the longitudinal position covariance parameter may be adjusted by the longitudinal data, and wherein the lateral position covariance parameter may be adjusted by the lateral data.

According to the present disclosure, a vehicle may comprise a first sensor and a second sensor configured to detect a surrounding environment of the vehicle, a driving control circuit configured to control autonomous driving of the vehicle, and a processor circuit configured to define a first sensor region based on first sensor data from the first sensor, and to define a second sensor region based on second sensor data from the second sensor, determine an association region based on characteristic information of at least one sensor of the first sensor or the second sensor, wherein the characteristic information may include an error attribute of the at least one sensor, and wherein the association region overlaps the first sensor region and the second sensor region, generate a correlation score indicating a degree of correspondence between the first sensor region and the second sensor region based on at least one of the characteristic information, region information of the first sensor region and the second sensor region, or a movement direction of an object detected in the surrounding environment, determine, based on the correlation score, whether the first sensor region and the second sensor region represent a same object, output, based on the determination of whether the first sensor region and the second sensor region represent the same object, a signal indicating a fusion region and fusion information, and control, via the driving control circuit and based on the signal, autonomous driving of the vehicle.

The processor circuit may be configured to generate the correlation score by setting longitudinal data of the object to fall within a longitudinal factor range, and setting lateral data of the object to fall within a lateral factor range.

The processor circuit may further be configured to, based on the correlation score satisfying a fusion condition, generate a single fusion region that identifies the first sensor region and the second sensor region as the same object, and, based on the correlation score not satisfying the fusion condition, generate an individual fusion region for each of the first sensor region and the second sensor region.

The features briefly summarized above for this disclosure are only examples of the detailed description of the disclosure which follow, and are not intended to limit the scope of the disclosure.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an exemplary vehicle that communicates with another device to transmit and receive data;

FIG. 2 shows an exemplary modules constituting a vehicle;

FIG. 3 shows an exemplary modules constituting a server;

FIG. 4 shows an example of a method of fusing heterogeneous sensors;

FIG. 5A, FIG. 5B, and FIG. 5C show exemplary generation of an association region;

FIG. 6A and FIG. 6B show exemplary generation of a fusion region; and

FIG. 7 shows an example of computing system.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways, and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the present disclosure, expressions of location relations used in the present specification such as “upper”, “lower”, “left” and “right” are employed for the convenience of explanation, and in case drawings illustrated in the present specification are inversed, the location relations described in the specification may be inversely understood.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of heterogenous sensor fusion accuracy) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of heterogenous sensor fusion accuracy) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of heterogenous sensor fusion accuracy) described herein.

Minimum risk maneuver (MRM) operation(s) may also be controlled, for example, based on one or more features (e.g., features of heterogenous sensor fusion accuracy) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of heterogenous sensor fusion accuracy) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of heterogenous sensor fusion accuracy) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving level and/or autonomous driving activation/deactivation may also be controlled, for example, based on one or more features (e.g., features of heterogenous sensor fusion accuracy) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

Hereinafter, examples of the present disclosure will be described with reference to the accompanying drawings.

The present disclosure relates to techniques for improving the accuracy of object recognition and tracking in vehicles by fusing data from heterogeneous sensors such as cameras, lidars, and radars. Each sensor type provides different advantages and exhibits unique error characteristics. For example, a camera provides rich visual detail but limited distance accuracy, whereas a radar provides reliable distance and velocity measurements but less detail regarding object shape. Fusion methods may apply standardized criteria to combine sensor outputs without adequately reflecting these differences, which may lead to inaccurate results. According to the present disclosure, fusion accuracy is enhanced by adaptively generating association regions that reflect sensor-specific error attributes and by further considering the movement direction of detected objects. Correlation scores are determined based on factors such as positional error, overlap ratios, and area ratios between sensor regions. Based on these scores, fusion regions are generated that more reliably represent real objects in the surrounding environment. As a result, vehicles may achieve more robust recognition of nearby objects and improved decision-making for autonomous or assisted driving functions.

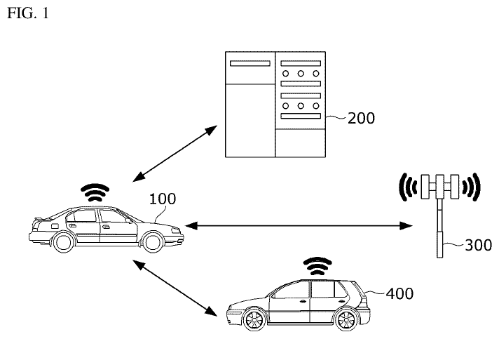

Hereinafter, a vehicle that processes the generation of a view image and a server that generates a model used for generating a view image will be described with reference to FIGS. 1 to 3.

FIG. 1 shows an exemplary vehicle that communicates with another device to transmit and receive data.

Referring to FIG. 1, a vehicle 100 may be driven based on electrical energy or fossil energy. In the case of electrical energy, the vehicle 100 may be, for example, a pure battery-based vehicle driven by only a high-voltage battery or may adopt a gas-based fuel cell as an energy source. In addition, a fuel cell may use various types of gases that may generate electrical energy, and the gas may be charged to the vehicle 100, for example, in a liquefied state. Here, the gas may be, for example, hydrogen. However, the present disclosure is not limited thereto, and various gases may be applied (e.g., methane, ammonia, natural gas, or biogas, etc.). In the case of fossil energy, the vehicle 100 may be driven based on fuel such as gasoline, diesel, liquefied gas, etc. and provided with an internal combustion engine that drives an actuating unit 116 by combustion of the fuel. The engine may be included in a power source unit 114 from the perspective of providing a driving rotational force of a wheel to a wheel driver. As another example, the vehicle 100 may drive the actuating unit 116 selectively using an internal combustion engine based on fossil energy and the energy of an electric battery, which may be a hybrid-type vehicle (e.g., parallel hybrid, series hybrid, plug-in hybrid, or mild hybrid, etc.).

The vehicle 100 may be a movable device. The vehicle 100 is a ground vehicle that travels on the ground and may be a typical passenger or commercial vehicle, a purpose built vehicle (PBV), etc. (e.g., taxi, delivery van, or ride-sharing shuttle, etc.). The vehicle 100 may be a four-wheeled vehicle, for example, a passenger car, an SUV, or a small truck, or a vehicle with more than four wheels, for example, a bus, a large truck, a container transport vehicle, a heavy equipment vehicle, dump truck, fire truck, crane, or excavator, etc. The vehicle 100 may be a robot in a broad sense, such as a means of transportation, and the robot may move using wheels, tracks, or other moving modules.

The vehicle 100 may be manually driven by a user or controlled by autonomous driving. The autonomous driving may be implemented as semi-autonomous driving or full autonomous driving. The full autonomous driving may be provided as autonomous movement in which a processor 120 of the vehicle 100 has full control authority without user intervention (e.g., lane keeping, automatic overtaking, highway merging, or parking without assistance, etc.) even if a traveling situation is uncertain. The semi-autonomous driving may be provided as autonomous movement that requires driver intervention depending on a specific traveling situation (e.g., construction zones, poor weather, unusual traffic signals, or emergency vehicle approach, etc.). The semi-autonomous driving may be implemented by allowing a user to perform manual driving by allowing the processor 120 to deactivate autonomous driving in case of an unexpected situation (e.g., sudden obstacle detection or malfunction of sensors, etc.) and transferring control authority to the user. According to the level of the autonomous driving defined by the Society of Automotive Engineers (SAE), the semi-autonomous driving corresponds to autonomous driving levels 1 to 4, and the full autonomous driving corresponds to level 5.

The vehicle 100 may communicate with other devices 200 and 300 or another vehicle 400. The other devices may include, for example, a server 200 for supporting various control, state management, and traveling of the vehicle 100, an intelligent transportation system (ITS) device 300 for receiving information from an ITS, or various types of user devices (e.g., smartphones, wearable devices, or tablets, etc.). The server 200 may be, for example, an external device operated by a vehicle manufacturer or provided to service autonomous driving and may receive connected data of the vehicle 100 or transmit data required for manual and autonomous driving. To support autonomous driving and various services of the vehicle 100, the server 200 may transmit various types of information and software modules (e.g., navigation updates, hazard alerts, AI-based driving strategies, or infotainment services, etc.) that are used for controlling the vehicle 100 to the vehicle 100 in response to the request and data transmitted from the vehicle 100 and the user device.

The ITS device 300 is, for example, a road side unit (RSU) and may exchange vehicle cognitive data, traveling control and state data, surrounding environmental data of a vehicle, map data, etc. with the vehicle 100 through vehicle-to-infrastructure (V2I) communication to assist a user driving his or her vehicle or support the autonomous driving of the vehicle 100 (e.g., signal phase and timing data, toll information, road hazard broadcasts, or congestion updates, etc.). The vehicle 100 may exchange the data listed above with another vehicle 400 through vehicle-to-vehicle (V2V) communication to support manual driving or autonomous driving (e.g., cooperative adaptive cruise control, collision warning, or platooning, etc.).

The vehicle 100 may communicate with another vehicle or other devices based on cellular communication, wireless access in vehicular environment (WAVE) communication, dedicated short range communication (DSRC), short-range communication, Bluetooth, Wi-Fi Direct, satellite communication, or another communication method.

For example, the vehicle 100 may use a communication network such as Long Term Evolution (LTE) or 5G, a Wi-Fi communication network, a WAVE communication network, etc. as a cellular communication network to communicate with the server 200, the ITS device 300, and another vehicle 400 (e.g., cloud-based traffic servers, road-side units, or fleet management centers, etc.). As another example, DSRC or the like used in the vehicle 100 may be used for communication between vehicles (e.g., cooperative adaptive cruise control, collision avoidance signaling, or platooning, etc.). A communication method between the vehicle 100, the server 200, the ITS device 300, another vehicle 400, and the user device is not limited to the above example.

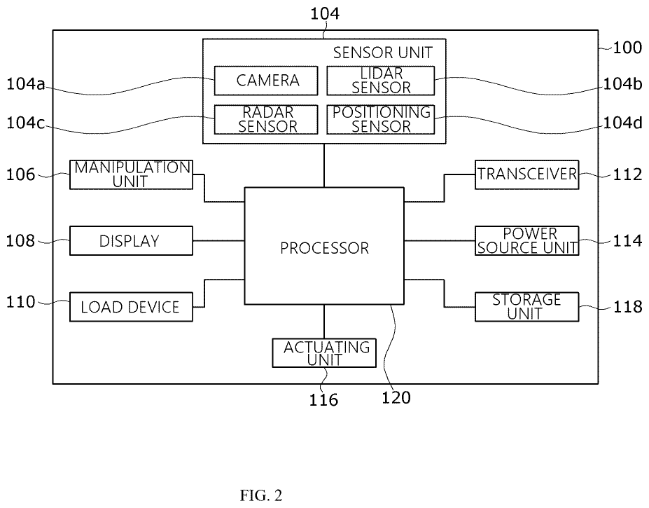

FIG. 2 shows an exemplary modules constituting a vehicle.

The vehicle 100 may include a sensor unit 104, a manipulation unit 106, a display 108, a load device 110, and a transceiver 112.

The sensor unit 104 may include various types of sensors for detecting various states and situations that occur in an external surrounding environment, internal system, user manipulation, and boarding space of the vehicle 100 (e.g., monitoring tire pressure, detecting rain on the windshield, identifying pedestrian movements, or sensing driver fatigue, etc.). Specifically, the sensor unit 104 may include a camera 104a, a lidar sensor 104b, a radar sensor 104c, etc. to recognize dynamic and static objects which are present around the vehicle 100.

The camera 104a may recognize an external object as an image while the vehicle 100 is being used to generate image data and transmit the image data to the processor 120. The camera 104a may be installed on a plurality of portions of the vehicle 100 so that a plurality of images or multi-views of the surrounding environment of the vehicle 100 may be acquired (e.g., front-view, rear-view, surround-view, or bird's-eye view, etc.). The lidar sensor 104b may generate point cloud data on objects around the vehicle 100 and transmit the point cloud data to the processor 120. The point cloud data includes three-dimensional information of an object, and the point cloud data may be referred to as lidar data in the present disclosure. The present disclosure provides an example in which the lidar sensor 104b is mounted, but in another example, the lidar sensor 104b may be omitted (e.g., when cost or weight reduction is prioritized, or when radar-only solutions are sufficient, etc.). The radar sensor 104c may emit radio waves of a specific frequency to a peripheral region of the vehicle 100 to generate radar data through radio waves reflected from an external object in order to identify the presence, relative distance, velocity, direction, etc., of the external object (e.g., detecting fast-approaching vehicles, measuring distance to nearby walls, or tracking the relative speed of a pedestrian, etc.).

In addition, the sensor unit 104 may include a positioning sensor 104d for identifying a position of the vehicle 100. The positioning sensor 104d may be, for example, a global positioning system (GPS) sensor or a global navigation satellite system (GNSS) sensor, but is not limited thereto (e.g., BeiDou, Galileo, or GLONASS systems may also be used, etc.). In addition, the sensor unit 104 may include an attitude sensor (not shown). The attitude sensor may detect, for example, a three-axis state of the vehicle 100, for example, yaw, pitch, and roll, and output various attitude states of the vehicle based on the above factors (e.g., tilting during cornering, body roll on uneven roads, or nose-diving during sudden braking, etc.). Examples of the attitude sensor may include an inertia measurement unit (IMU) sensor, a gyro sensor, etc.

The sensors of the sensor unit 104 referred to in the description of the present disclosure are mainly described, but sensors for detecting various situations, which are not listed above, may be additionally included (e.g., rain sensors, ultrasonic sensors, driver eye-tracking sensors, cabin temperature sensors, or biometric sensors, etc.).

The manipulation unit 106 may be formed as a module manipulated by a user for driving. For example, the manipulation unit 106 may be a steering wheel for manual driving, an automatic or manual transmission, an accelerator pedal, a brake pedal, a gear transmission, a joystick-type control, or a haptic feedback controller, etc. The manipulation unit 106 may further include an interface for using, deactivating, and selecting a specific function of an autonomous driving mode requested by the user so that the user may use the autonomous driving function. To receive various requests related to autonomous driving, the manipulation unit 106 may be composed of, for example, a hard type interface provided at a predetermined location in the vehicle 100 or a soft type interface that may be touched on the display 108 (e.g., a button on the dashboard, a rotary dial, or a voice-activated virtual assistant, etc.).

The display 108 may serve as a user interface. The display 108 may be controlled by the processor 120 to display an operation state, control state, route/traffic information, and the remaining energy information of the vehicle 100, content requested by a driver, etc. In addition, the display 108 may be formed as a touch screen capable of detecting the input of the driver to receive the request of the driver that instructs the processor 120 (e.g., route selection, media playback, climate control, or driver authentication input, etc.).

The load device 110 may be mounted on the vehicle 100 and may be a type of non-driving electric device excluding a driving power system such as the wheel driver or the like. The load device 110 is an auxiliary device for receiving power from the power source unit 114 and may be, for example, an air conditioning system, a lighting system, a seat system, an infotainment system, or a heating/ventilation system, etc., and various devices installed on the vehicle 100.

The transceiver 112 may support mutual communication with the server 200, the ITS device 300, a nearby vehicle 400, etc. The transceiver 112 may include, for example, a module for processing cellular communication, WAVE communication, DSRC, Bluetooth, or Wi-Fi Direct, etc. In the present disclosure, the transceiver 112 may transmit data generated or stored during driving to the server 200 and receive data and a software module transmitted from the server 200. The transceiver 112 may support communication with an electronic device of a passenger in the vehicle 100 (e.g., a smartphone, tablet, smartwatch, or laptop, etc.). In the present disclosure, the vehicle 100 may transmit and receive data used in the method according to the present disclosure with an external device through the transceiver 112.

In addition, the vehicle 100 may include the power source unit 114 and the actuating unit 116.

The power source unit 114 may generate and supply power and electric power that are used in a driving power system such as the actuating unit 116 and a non-driving power system. The non-driving power system may include, for example, the sensor unit 104, the manipulation unit 106, the display 108, the load device 110, the transceiver 112, etc., but is not limited thereto, and may include various components for implementing sensing, interface, communication, and convenience functions other than components directly involved in driving operations (e.g., charging ports, wireless chargers, electronic control modules, or cabin air purification systems, etc.).

When the vehicle 100 is driven based on electrical energy, the power source unit 114 may be formed as, for example, an electric battery charged from the outside or formed as a combination of an electric battery and a fuel cell that charges the battery. In the case of a combination of the electric battery and the fuel cell, the power source unit 114 may include a tank that stores a material used to produce power for the fuel cell, for example, liquefied hydrogen (e.g., liquid hydrogen tanks, compressed hydrogen tanks, or methanol reformers, etc.). When the vehicle 100 is driven based on fossil energy, the power source unit 114 may be formed as an internal combustion engine. In addition, when the vehicle 100 is a hybrid type, the power source unit 114 may be provided as a combination of the internal combustion engine and the electric battery (e.g., plug-in hybrid, mild hybrid, or range extender configurations, etc.).

The actuating unit 116 may include at least one module that implements a driving operation and perform at least one driving operation of longitudinal control such as acceleration and deceleration and lateral control such as steering, and gear shifting according to a user request from the manipulation unit 106 or a request of the processor 120. Here, the gear shifting may be processed by a request of a manual driving user using a gear transmission or a request of the processor 120 in autonomous driving (e.g., during adaptive cruise control, automated lane changes, or parking assist, etc.).

The actuating unit 116 may have a wheel driver (not shown) and a mechanical component and an electronic module for implementing a driving operation in the wheel driver in order to perform a driving operation according to a command of the processor 120 by a manual manipulation of the user or autonomous driving (e.g., an inverter, an electric motor, or a regenerative braking unit, etc.). When the vehicle 100 is operated based on electrical energy, the vehicle 100 may include an assembly for transmitting the requested driving operation to the wheel driver. When the vehicle 100 is operated based on fossil energy, the actuating unit 116 may include a transmission and a gear module for transmitting the power of an internal combustion engine (e.g., an automatic transmission, dual-clutch transmission, or continuously variable transmission (CVT), etc.).

The wheel driver may include a plurality of wheels, a driving force generation module for generating a driving force to impart the driving force to wheels or transmitting the driving force, a brake module for decelerating the driving of the wheels, a steering module for achieving lateral control of the wheels, a suspension system, or a traction control system, etc. When the vehicle 100 is driven based on electrical energy, the driving force generation module may be provided as a motor assembly for generating a driving force based on the power output from the electric battery (e.g., an induction motor, a permanent magnet synchronous motor, or a switched reluctance motor, etc.). The brake module of the electricity-based vehicle 100 may further have a regenerative brake function (e.g., energy recovery during deceleration, downhill braking, or stop-and-go traffic, etc.).

In addition, the vehicle 100 may include a memory 118 and the processor 120.

The memory 118 may store applications and various types of data for controlling the vehicle 100 and load the applications or read or write the data at the request of the processor 120. In the present disclosure, the memory 118 may store an application and at least one instruction for generating a view image around the vehicle 100 according to an example of the present disclosure. The application may include generating an association region overlapping each sensor region (e.g., overlapping areas from a front camera and a lidar field of view, or overlapping radar and camera detection zones, etc.) based on sensor data of each heterogeneous sensor based on characteristic information of a specific sensor. The application may include generating association information including correlation scores related to a plurality of sensor regions belonging to the association region and generating a fusion region and fusion information based on the correlation scores.

The memory 118 may store various pieces of information and data used in the application for executing the fusion of heterogeneous sensors according to the present disclosure. For example, the memory 118 may have internal parameters including unique attributes such as a focal length, a principal point, a lens curvature, a resolution, or a distortion coefficient, etc., of the camera 104a, and external parameters according to a position and orientation of the camera 104a. The memory 118 may store parameters, specification attribute data, positions, orientations, field-of-view angles, or calibration matrices, etc. that are related to the lidar sensor 104b and the radar sensor 104c. In addition, the memory 118 may include characteristic information of each sensor related to an error attribute of each sensor. For example, the characteristic information may be a position error caused by a sensor region generated based on sensor data of each sensor in the unique space of each sensor or the fusion space of the sensors. The position error may be, for example, a position covariance parameter. The position covariance parameter may be defined in a longitudinal direction and a lateral direction defined in spatial coordinates. Specifically, the position covariance parameter may include a longitudinal position covariance parameter and a lateral position covariance parameter (e.g., forward/backward error margins vs. side-to-side error margins, etc.). When the characteristic information is data causing a position error, the present disclosure is not limited to the above example.

The processor 120 may perform the overall control of the vehicle 100. The processor 120 may be configured to execute applications and instructions that are stored in the memory 118. The processor 120 may generate control instructions for components of the vehicle 100 according to driving control requests in manual driving and autonomous driving. The component may be at least one of various members described in FIG. 2 (e.g., the actuating unit 116, the transceiver 112, the display 108, or the load device 110, etc.).

The processor 120 may execute various types of processing related to the fusion of heterogeneous sensors according to the present disclosure. Specifically, the processor 120 may execute processing for generating each sensor region based on sensor data of each heterogeneous sensor and generating an association region (e.g., an overlap between radar detection zones and lidar point cloud regions, or overlap between multiple camera fields of view, etc.) based on characteristic information of one of heterogeneous sensors. The sensor region may be, for example, a sensor track generated based on sensor data (e.g., a moving object trajectory detected by radar or a vehicle outline extracted from a camera image, etc.). The processor 120 may execute processing for generating association information including correlation scores based on region information corresponding to a plurality of sensor regions, each of which overlaps an association region, and generating a fusion region and fusion information based on the correlation scores. In the present disclosure, the association region may be referred to as a gate that designates a plurality of sensor regions used to generate correlation scores. The fusion region may be referred to as a sensor fusion track that links sensor regions estimated to be the same object (e.g., matching a pedestrian identified by lidar with the same pedestrian identified by a camera, etc.). The detailed description of the above processing will be described below.

The processor 120 is formed as a single processing module, as shown in FIG. 2, to execute the above processing. In another example, the processor 120 may be composed of a plurality of processing modules, and the processing may be distributed and processed in the plurality of modules (e.g., a CPU handling camera image processing, a GPU handling neural network inference, and an FPGA handling real-time radar data processing, etc.).

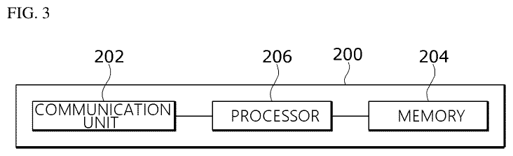

FIG. 3 shows an exemplary modules constituting a server.

The server 200 may transmit response data according to the request of the vehicle 100 to the vehicle 100 and also transmit information for supporting an application embedded in the vehicle 100 or supporting vehicle driving (e.g., real-time navigation data, updated object recognition models, or over-the-air software updates, etc.). The server 200 may include a communication unit 202, a memory 204, and a processor 206.

The communication unit 202 may transmit and receive data with an external device, support mutual communication with the vehicle 100 in the present disclosure, and exchange data with the vehicle 100 (e.g., V2X messages, road hazard warnings, or traffic signal information, etc.).

The memory 204 may store a program and various types of data for operating the server 200 and load the program or read and record the data at the request of the processor 206. The memory 204 may store and manage a program for processing a request of the vehicle 100, an application embedded in the vehicle 100, and information for supporting driving (e.g., map data, sensor fusion calibration parameters, or machine learning weights, etc.).

The processor 206 may perform the overall control of the server 200. The server 200 may be configured to execute the program and instructions that are stored in the memory 204. The processor 206 may execute the program to process and respond to a user request transmitted from the vehicle 100.

In the present disclosure, the processor 206 is, for example, formed as a single processing module. As another example, the processor 206 may include a plurality of processing modules in a distributed manner, and the above processing may be performed by the distributed processing modules (e.g., a cloud-based distributed inference system where one module processes camera data and another handles lidar mapping, etc.).

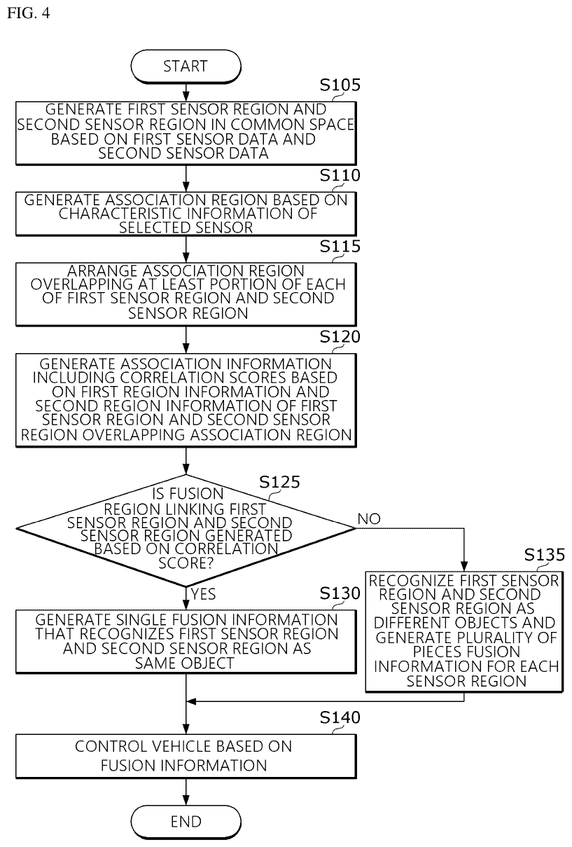

Hereinafter, a method of fusing heterogeneous sensors according to another example of the present disclosure will be described in detail with reference to FIG. 4. FIG. 4 shows an example of a method of fusing heterogeneous sensors according to another example of the present disclosure.

Hereinafter, the first sensor, the second sensor, and the third sensor shown in FIG. 4 are exemplified as being the lidar sensor 104b, the camera 104a, and the radar sensor 104c, respectively, and the reference numerals of the lidar sensor 104b, the camera 104a, and the radar sensor 104c may be used for the first sensor, the second sensor, and the third sensor. In addition, “first” may be written in front of terms of information and data related to the lidar sensor 104b, and “second” may be written in front of terms of information and data related to the camera 104a. “Third” may be written in front of terms of information and data related to the radar sensor 104c. The fusion of the camera 104a and the lidar sensor 104b will be mainly described in FIG. 4, but the following description may also be applied to the fusion of two sensors other than the above sensors (e.g., camera+radar) or the fusion of all three sensors. In addition, the method of the present disclosure is performed by the processor 120, but, for convenience of description, the processor 120 and the vehicle 100 may be used interchangeably.

Referring to FIG. 4, the vehicle 100 may generate a first sensor region and a second sensor region in a common space based on first sensor data of the lidar sensor 104b and second sensor data of the camera 104a (S105).

The first sensor data and the second sensor data may be sensor data including objects in the surrounding environment. The first sensor data and the second sensor data may be lidar data and image data (e.g., 3D point cloud data from lidar and 2D RGB image frames from a forward camera, etc.).

For example, the processor 120 may align the first sensor data and the second sensor data and arrange the first sensor data and the second sensor data in the common space. The common space may be a unique space (or unique coordinate system) of each sensor or a vehicle-centered space (or world coordinate system) based on a predetermined point of the vehicle 100. Arrangement in the common space may be performed by projecting the sensor data onto the common space (e.g., lidar point clouds projected into a camera image plane, or camera pixels re-projected into a 3D lidar space, etc.). The processor 120 may generate first object information from the first sensor data in the common space using an object detection model of the lidar data. The processor 120 may generate second object information from the second sensor data in the common space using an object detection model of the image data. The object detection model may be, for example, a learning-based object recognition network that uses lidar data and image data as an input (e.g., PointNet++, YOLO, or multimodal CNN architectures, etc.).

The first object information may include, for example, a first sensor region surrounding an object to identify the object, a first position of the object or the first sensor region, a first distance of the object or the first sensor region, a first area of the first sensor region, a first velocity of the object, and a first class of the object. The first sensor region may be implemented, for example, as a bounding box provided in three dimensions or two dimensions. The first class may include, for example, an identifier of an object and a type of the object (e.g., “pedestrian,” “sedan,” or “truck,” etc.).

The second object information may include, for example, a second sensor region surrounding an object to identify the object, a second position of the object or the second sensor region, a second distance of the object or the second sensor region, a second area of the second sensor region, a second velocity of the object, and a second class of the object. The second sensor region may be implemented, for example, as a bounding box provided in two dimensions. The second class may include, for example, an identifier of an object and a type of the object (e.g., “cyclist,” “SUV,” or “traffic light,” etc.).

As another example, the processor 120 may generate first object information from the first sensor data using the object detection model of the lidar data (e.g., a 3D bounding box detector, a clustering-based detector, or a point-cloud neural network, etc.) and generate second object information from the second sensor data using the object detection model of the image data (e.g., a convolutional neural network, a region proposal network, or a YOLO-based detector, etc.). The object detection model and the object information may be substantially the same as those described above.

The processor 120 may align the first object information and the second object information and arrange the first object information and the second object information in a common space (e.g., a vehicle-centered coordinate system, a world coordinate system, or a bird's-eye view projection, etc.). The common space and the arrangement in the space may be substantially the same as those described above.

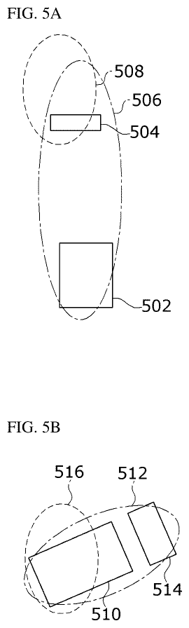

According to the above examples, the first sensor region of the first object information and the second sensor region of the second object information may be generated in the common space, and other data listed in the first and second object information may also be connected to and embedded in the first and second sensor regions (e.g., velocity data, class identifiers, or confidence scores, etc.). FIGS. 5A and 5B show first sensor regions 502 and 510 and second sensor regions 504 and 514 arranged in the common space. FIGS. 5A, 5B and 5C show exemplary generation of an association region.

When the radar data of the radar sensor 104c is further included to generate a third sensor region, a first sensor region 518, a second sensor region 520, and a third sensor region 522 may be arranged in the common space as in the example of FIG. 5C. In this case, other data of the first to third object information other than the sensor region may also be connected and embedded in the first to third sensor regions 518 to 522, respectively (e.g., range rate from radar, depth information from lidar, or texture features from camera, etc.).

Referring to FIG. 4, the processor 120 may generate an association region based on the characteristic information of any one sensor selected from the lidar sensor 104b and the camera 104a (S110).

The selection of the sensor may include specifying any one of the first and second object information of a plurality of sensors as reference object information and selecting a sensor related to non-specified object information as a sensor for which characteristic information is requested (e.g., choosing lidar as reference and requesting image-based covariance, or choosing camera as reference and requesting lidar-based distance accuracy, etc.). Here, the reference object information may include at least a sensor region of the specified object information. In the present disclosure, an example in which the first object information of the lidar sensor 104b is specified as the reference object information and the camera 104a related to the second object information is the sensor for which characteristic information is requested. It is obvious that the present disclosure may also be applied to an example in which an association region is generated by the characteristic information of the lidar sensor 104b.

The characteristic information may include an error attribute of the selected sensor (e.g., position error, orientation error, or scale error, etc.). The error attribute may be a position error that the sensor region of the selected sensor causes in a common space or a unique space for each sensor. The position error may be, for example, a position covariance parameter (e.g., variance in meters, standard deviation in pixels, or error ellipses, etc.). The position covariance parameter may be defined in at least one of a longitudinal direction and a lateral direction defined in spatial coordinates. When the selected sensor is the second sensor (e.g., the camera 104a), the error attribute in the characteristic information of the second sensor may include at least one of a longitudinal position covariance parameter of the second sensor and a lateral position covariance parameter of the second sensor. The covariance parameter related to the error attribute may increase in a long-distance region among detection regions of the sensors (e.g., objects beyond 80 meters for lidar, beyond 100 meters for radar, or at the far edge of the camera's field of view, etc.). The longitudinal position covariance parameter and the lateral position covariance parameter may be dynamically determined according to a distance.

For example, the longitudinal position covariance parameter of the second sensor may be dynamically provided according to a longitudinal distance of the second sensor region or an object belonging to the region (e.g., a vehicle at 30 m, a pedestrian at 50 m, or a signboard at 80 m, etc.). The longitudinal distance may be acquired from the second distance and the second position included in the second object information. Specifically, the longitudinal position covariance parameter may be a covariance value distributed according to the longitudinal distance of the object in a grid map based on the second sensor (e.g., a 2D grid map, a voxel grid, or a polar-coordinate grid, etc.). The longitudinal position covariance parameter may be determined through a grid map having a covariance value that increases as the longitudinal distance of the object increases. If there is no covariance value corresponding to the longitudinal distance in the grid map, the processor 120 may generate the longitudinal position covariance parameter using interpolation in the grid map (e.g., linear interpolation, spline interpolation, or nearest-neighbor interpolation, etc.).

The lateral position covariance parameter of the second sensor may be provided dynamically, for example, depending on the lateral distance of the second sensor region or an object belonging to the region (e.g., a pedestrian near the curb, a bicycle in an adjacent lane, or a roadside sign, etc.). The lateral distance may be acquired from the second distance and the second position included in the second object information. Specifically, the lateral covariance parameter may be a covariance value distributed according to the lateral distance of the object in the grid map based on the second sensor (e.g., a polar grid, a voxel grid, or a Cartesian 2D occupancy grid, etc.). The lateral covariance parameter may be determined through a grid map having a covariance value that increases as the lateral distance of the object increases. When there is no covariance value corresponding to the lateral distance in the grid map, the processor 120 may generate the lateral position covariance parameter using interpolation in the grid map (e.g., linear interpolation, cubic spline interpolation, or nearest-neighbor interpolation, etc.).

According to the type of sensor, the error attribute related to the covariance parameter may depend on one of the lateral distance and the longitudinal distance of the object (e.g., radar error grows with longitudinal range, camera error grows with lateral displacement, or lidar error grows with sparse point density, etc.). For example, if the sensor has an error attribute dependent on the longitudinal distance of the object, the longitudinal position covariance parameter may be greater than the lateral covariance parameter at the same distance even at the same lateral distance and longitudinal distance (e.g., a vehicle detected at 100 m longitudinally will show higher longitudinal error than lateral error, etc.). If the characteristic information is data causing a position error, the present disclosure is not limited to the above example.

The association region may be adaptively generated based on the characteristic information of the selected sensor. If the characteristic information includes both the longitudinal position covariance parameter and the lateral position covariance parameter, the association region may be adaptively generated based on, for example, a ratio between the longitudinal position covariance parameter and the lateral position covariance parameter (e.g., a 2:1 ratio, a 3:2 ratio, or a 1:1 ratio, etc.).

If the longitudinal position covariance parameter is larger than the lateral position covariance parameter, an association region 506 may be adaptively generated to have a longitudinal width larger than a lateral width based on the parameters (e.g., elongated ellipses in the direction of travel, rectangular regions extended forward, or stretched bounding boxes, etc.) as shown in FIG. 5A. If the lateral position covariance parameter is larger than the longitudinal position covariance parameter, an association region 512 may be adaptively generated to have a lateral width larger than a longitudinal width based on the parameters (e.g., wide ellipses across lanes, rectangular regions extended sideways, or broadened bounding boxes, etc.) as shown in FIG. 5B. As described above, the association regions 506 and 512 may be generated based on the covariance parameters according to the distance of the object, that is, the longitudinal position covariance parameter and the lateral position covariance parameter.

FIG. 5C shows that a plurality of association regions 524 and 526 are generated in a space having the first sensor region 518 of the lidar sensor 104b, the second sensor region 520 of the camera 104a, and the third sensor region 522 of the radar sensor 104c. The association region 524 may be adaptively generated based on the characteristic information of the camera 104a. For example, the association region 524 may be adaptively generated to have a longitudinal width larger than a lateral width depending on a ratio between parameters similar to those in FIG. 5A (e.g., a 2:1 ratio yielding narrow lateral confidence, or a 4:1 ratio yielding elongated frontal confidence, etc.). Regarding the association region 526, the sensor selected to acquire the characteristic information may be the radar sensor 104c. The characteristic information of the radar sensor 104c may include, for example, a longitudinal position covariance parameter of the radar sensor 104c and a lateral position covariance parameter of the radar sensor 104c (e.g., derived from range-Doppler maps, angular resolution limits, or signal-to-noise ratios, etc.). If the longitudinal position covariance parameter and the lateral position covariance parameter are substantially the same and have a ratio of 1, the association region 526 may be generated to have the same width in longitudinal and lateral directions (e.g., circular or square-shaped association regions, etc.) as shown in FIG. 5C.

Referring to FIG. 4, the processor 120 may arrange the association regions so that an association region overlaps at least a portion of each of the first sensor region and the second sensor region (S115).

As shown in FIGS. 5A and 5B, the association regions 506 and 512 may overlap the first sensor regions 502 and 510 and the second sensor regions 504 and 514 so that one end of the association regions 506 and 512 is arranged on one end of the first sensor regions 502 and 510 related to the reference object information specified in operation S110. In addition, the association regions 506 and 512 may be arranged to overlap the first sensor regions 502 and 510 and the second sensor regions 504 and 514 as much as possible (e.g., covering shared vehicle contours, overlapping common pedestrian outlines, or spanning bicycle boundaries, etc.). As another example, the association regions may overlap the first sensor region and the second sensor region so that one end of an association region is arranged on one end of the second sensor region not related to the reference object information (e.g., aligning to camera-only boundaries, lidar-only detections, or radar-only confidence ellipses, etc.).

When three sensor regions are provided as in FIG. 5C, the association region 524 may overlap the first sensor region 518 and the second sensor region 520 so that one end of the association region 524 is arranged on one end of the first sensor region 518 that serves as a reference among the first and second sensor regions 518 and 520 (e.g., lidar as the reference and camera as the secondary, etc.). The association region 526 may overlap the second and third sensor regions 520 and 522 so that one end of the association region 526 is arranged on one end of the second sensor region 520 that serves as a reference among the second and third sensor regions 520 and 522 (e.g., camera as the reference and radar as the secondary, etc.).

The arrangement of the association region is not limited to the above example and may be performed in various ways (e.g., overlapping diagonally, partially covering edge boundaries, or aligning center-to-center, etc.).

FIG. 5A shows that the association region 508 is provided to have a fixed (or unchanging) size without reflecting the characteristic information of a sensor, for example, an error attribute (e.g., ignoring distance-related uncertainty, ignoring angular resolution, or ignoring detection density, etc.). The adaptive association region 506 completely overlaps the first sensor region 502 and the second sensor region 504, but the fixed association region 508 may not cover the first sensor region 502 and may overlap only the second sensor region 504. FIG. 5B shows that the association region 516 is provided to have a fixed (or unchanging) size without reflecting the characteristic information of a sensor, for example, an error attribute (e.g., treating a near object the same as a far object, treating a small object the same as a large one, etc.). The adaptive association region 512 completely overlaps the first sensor region 502 and the second sensor region 504, but the fixed association region 516 may not cover the second sensor region 514 and may overlap only the first sensor region 510. According to the examples of FIGS. 5A and 5B, since the size of the association region reflects the characteristics of each sensor, for example, an error attribute (e.g., camera error grows laterally, radar error grows longitudinally, or lidar error grows with distance, etc.), the determination of object identity for a plurality of sensor regions may be performed accurately.

Referring to FIG. 4, the processor 120 may generate association information including correlation scores based on the first region information and the second region information of the first sensor region and the second sensor region, each of which overlaps the association region (S120).

The processor 120 may identify a sensor region belonging to an association region and generate a correlation score based on region information of the identified sensor region (e.g., center coordinates, shape boundaries, or relative distance, etc.). In the present disclosure, an example in which at least a portion of each of the sensor regions shown in FIGS. 5A and 5B, that is, the first sensor region of the lidar sensor 104b and the second sensor region of the camera 104a, overlaps the association region will be described.

The first region information may include data related to the first sensor region, for example, the first position and the first area (e.g., centroid point, bounding box size, or contour outline, etc.). The second region information may include data related to the second sensor region, for example, the second position and the second area (e.g., detected pixel cluster, estimated object footprint, or bounding ellipse, etc.).

The correlation score may be generated based on a distance error, an overlap ratio, and an area ratio (e.g., normalized Euclidean error, intersection-over-union (IoU), or proportional area matching, etc.). The correlation score may be generated based on one of the overlap ratio and the area ratio and the distance error in another example (e.g., using only IoU and distance, or only area ratio and distance, etc.). In the present disclosure, an example in which the correlation score is generated based on the distance error, the overlap ratio, and the area ratio may be described.

The distance error may include an error of a position of a sensor region in a non-reference sensor with respect to a position of the sensor region in a reference sensor related to the reference object information (e.g., comparing camera bounding box center vs. lidar centroid, etc.). In the present disclosure, for convenience of description, an example in which the reference sensor related to the reference object information specified in operation S110 is the first sensor and the non-reference sensor involving the use of the characteristic information is the second sensor (e.g., the camera 104a) may be described. As described in operation S110, the characteristic information may include the error attribute of the second sensor, and the distance error may be generated by reflecting the error attribute of the second sensor (e.g., pixel localization noise, lens distortion, or motion blur, etc.).

The distance error may be generated by reflecting the error attribute of the second sensor and the movement direction of the object (e.g., forward driving, lateral lane change, diagonal crossing, or backward movement, etc.). Here, the object may be recognized in at least one of the first sensor region and the second sensor region.

The error attribute of the second sensor may be, for example, substantially the same as the error attribute described in operation S110. Specifically, the error attribute of the second sensor may include at least one of the longitudinal position covariance parameter of the second sensor and the lateral position covariance parameter of the second sensor (e.g., standard deviation along X-axis, variance along Y-axis, or elliptical error spread, etc.). As described in operation S110, the longitudinal position covariance parameter and the lateral position covariance parameter may be determined depending on the longitudinal distance of the object and the lateral distance of the object.

The movement direction of the object may include longitudinal data of the object and lateral data of the object. The longitudinal data of the object may be generated based on a ratio of a longitudinal velocity of an object to a lateral velocity of the object (e.g., velocity ratio=5:1 indicating forward motion, or 1:3 indicating lateral drift, etc.), and the lateral data of the object may be generated based on a ratio of the lateral velocity of the object to the longitudinal velocity of the object. The longitudinal data may be generated to be set within a longitudinal factor range, and the lateral data may be generated to be set within a lateral factor range (e.g., normalized range from 0-1, scaled factors 0.2-2.0, etc.). The longitudinal velocity and the lateral velocity may be provided based on at least one of the first velocity of the first object information and the second velocity of the second object information (e.g., lidar velocity estimation, radar Doppler velocity, or camera optical flow velocity, etc.). Here, the distance error may be generated by reflecting the longitudinal position covariance parameter adjusted by the longitudinal data and the lateral position covariance parameter adjusted by the lateral data (e.g., scaling covariance by velocity ratios, weighting error based on movement trends, or adjusting error ellipse size, etc.).

In addition, during the process of generating the correlation score, the score related to the distance error may be dynamically changed by reflecting the distance of the object identified from the object information (e.g., a vehicle ahead at 100 m, a pedestrian crossing at 30 m, or a bicycle approaching from 50 m, etc.). For example, even if the distance error according to the following Equation 2 is considerably large, the score related to the distance error may decrease as the object distance increases (e.g., objects at far range contribute less to fusion errors than nearby objects, etc.).

The overlap ratio of the correlation score may be, for example, an overlap ratio of the first sensor region and the second sensor region (e.g., camera bounding box overlapping lidar point cloud cluster, radar detection overlapping lidar detection, or thermal image overlapping camera bounding box, etc.). Specifically, the overlap ratio may be a ratio of an overlapping area of the first sensor region and the second sensor region to a total area of the first area and the second area (e.g., overlap area/union area similar to IoU, etc.). The area ratio of the correlation score may be related to, for example, the ratio of the overlapping area of the first and second sensor regions to the first area or the second area (e.g., overlap compared only to lidar footprint, or overlap compared only to camera bounding box, etc.).

The correlation score according to the above matters may be generated by Equation 1.

$$AssocScore = ( α \cdot MDError + β \cdot OvrelapRatio + γ \cdot AreaRatio ) \cdot {Factor}_{ID} \qquad [ Equation 1 ]$$

Here, AssocScore, Medrol, OverlapRatio, and AreaRatio denote a correlation score, a distance error, an overlap ratio, and an area ratio, respectively. FactorID may be an association between sensor regions (or sensor tracks) mutually fused at a time point before acquiring the first and second sensor regions or in a previous frame and a currently acquired sensor region or influences of previously mutually fused sensor regions (e.g., persistence of a tracked car across frames, continuation of a pedestrian trajectory, or re-detection of a static traffic sign, etc.). α, β, and γ denote weighing coefficients, and these coefficients may have different signs (+, −). The weighting coefficients may be arbitrarily set by the processor 120 or the user (e.g., prioritizing distance error over area ratio, assigning negative weights to penalize poor overlaps, or dynamically adapting weights based on object class, etc.).

The distance error may be generated by Equation 2.

$$MDError = \frac{\sqrt{{( L o n g P o {s}_{Ref} - L o n g P o {s}_{Trgt} )}^{2}}}{S e n s o r C o {v}_{L o n g} \cdot CovFacto {r}_{L o n g}} + \frac{\sqrt{{( L a t P o {s}_{Ref} - L a t P o {s}_{Trgt} )}^{2}}}{S e n s o r C o {v}_{Lat} \cdot CovFacto {r}_{Lat}} \qquad [ Equation 2 ]$$

Here, LongPos_{Ref}, LongPos_{Tryt}, LatPos_{Ref}, and LatPos_{Trgt} denote a longitudinal position of the first sensor region of the first sensor (the reference sensor), a longitudinal position of the second sensor region of the second sensor, a lateral position of the first sensor region of the first sensor (the reference sensor), and a lateral position of the second sensor region of the second sensor, respectively (e.g., lidar centroid vs. camera bounding box center, etc.). Sensor COV_{Long} and Sensor COV_{Lat} denote the characteristic information of the second sensor, that is, an error attribute, and may be the longitudinal position covariance parameter of the second sensor and the lateral position covariance parameter of the second sensor (e.g., higher uncertainty in radar lateral measurement, higher error in camera depth estimation, etc.).

In addition, in Equation 2, CovFactor_{Long} and CovFactor_{Lat} denote information related to the movement direction of the object belonging to the first sensor region or the second sensor region, and they may be longitudinal data of the object and lateral data of the object, respectively (e.g., forward motion in highway driving, lateral lane-change maneuvers, or diagonal pedestrian crossings, etc.). As may be seen in Equation 2, the distance error AssocScore may be generated by reflecting the longitudinal position covariance parameter Sensor COV_{Long} adjusted by the longitudinal data CovFactor_{Long} and the lateral position covariance parameter Sensor COV_{Lat} adjusted by the lateral data CovFactor_{Lat} (e.g., scaling covariance when the object accelerates forward, or reducing weight when lateral drift is detected, etc.).

In addition, as shown in Equations 3 and 4, the longitudinal data CovFactor_{Long} and the transverse data CovFactor_{Lat} may be generated to be set within a longitudinal parameter range Min_Long to Max_Long, and the lateral data may be generated to be set within a lateral parameter range Min_Lat to Max_Lat (e.g., Min/Max values may be determined by road geometry, sensor FOV, or safety thresholds, etc.).

$${CovFactor}_{L o n g} = \frac{A b s L o n g V e l}{A b sLatVel} ( Min\_Long < C o v F a c t o {r}_{L o n g} < Max\_Long ) \qquad [ Equation 3 ]$$

$${CovFactor}_{Lat} = \frac{A b s L a t V e l}{A b s L o n g V e l} ( Min\_Lat < C o v F a c t o {r}_{Lat} < Max\_Lat ) \qquad [ Equation 4 ]$$

In Equations 3 and 4, AbsLongVel and AbsLatVel denote the longitudinal velocity of the object and the lateral velocity of the object, respectively, and the longitudinal data and the lateral data may be generated based on the ratio between the longitudinal velocity and the lateral velocity (e.g., forward speed of 20 m/s vs. lateral drift of 2 m/s, or pedestrian walking laterally at 1 m/s with minimal forward velocity, etc.).

Referring to FIG. 4, the processor 120 may determine whether to generate a fusion region that links the first sensor region and the second sensor region generated based on the correlation score (S125).

The processor 120 may determine whether the correlation score satisfies a single fusion condition that links the first and second sensor regions. For example, in Equation 1, in a case in which the score of the distance error is generated with a negative sign and the scores related to the overlap ratio and the area ratio is generated with a positive sign (e.g., camera depth error penalized while lidar-camera overlap rewarded, radar error down-weighted while bounding-box IoU rewarded, etc.), if the correlation score is greater than or equal to a threshold value, the processor 120 may determine that the first and second sensor regions satisfy the single fusion condition. As another example, in a case in which the sign in Equation 1 differs from the above example, (e.g., distance error rewarded in certain contexts, overlap ratio penalized in cluttered regions, or area ratio given negative weighting in occlusion cases, etc.) if the correlation score is smaller than or equal to the threshold value, the processor 120 may determine that the single fusion condition is satisfied.

In response to the correlation score that satisfies the single fusion condition, the processor 120 may generate a single fusion region that recognizes the first sensor region and the second sensor region as the same object and generate single fusion information about the single fusion region (S130).

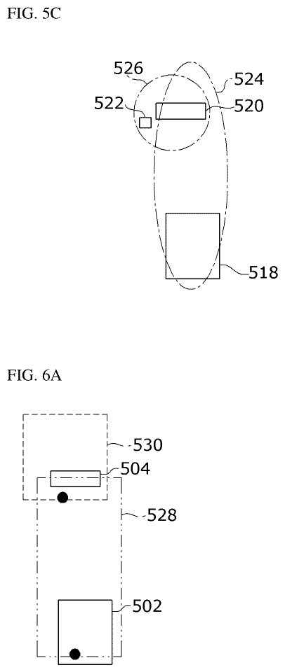

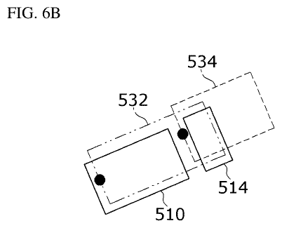

FIGS. 6A and 6B show exemplary generation of a fusion region.

According to an example of FIG. 6A, the first sensor region 502 and the second sensor region 504 may be linked into a single fusion region 528. Since the correlation score is generated based on the distance error reflecting the characteristic information of the second sensor (e.g., camera depth uncertainty increasing with distance, radar lateral inaccuracy growing with distance, lidar point cloud sparsity at far range, etc.), the first sensor region 502 and the second sensor region 504 generated in a region located at a long distance in a longitudinal direction may be fused into the single fusion region 528. A fusion region 530 that does not reflect the characteristic information of the second sensor in the distance error while using the fixed association region may include only the second sensor region 504, and the first sensor region 502 may be recognized as a different fusion region from the second sensor region 504.

According to an example of FIG. 6B, the first sensor region 510 and the second sensor region 514 may be linked into a single fusion region 532. Since the correlation score is generated based on the distance error reflecting the movement direction of the object, for example, the lateral movement (e.g., a car changing lanes, a cyclist veering sideways, or a pedestrian crossing laterally, etc.), the first sensor region 510 and the second sensor region 514 generated in the lateral direction may be fused into the single fusion region 532. A fusion region 534 that does not reflect the movement direction of the object in the distance error while using the fixed association region may include only the second sensor region 514, and the first sensor region 510 may be recognized as a different fusion region from the second sensor region 514.

The single fusion information may be generated based on the first object information of the first sensor region and the second object information of the second sensor region. Specific data of each object information is substantially the same as described above, and the single fusion information may include a plurality of pieces of specific data (e.g., object ID, bounding box coordinates, velocity vectors, classification confidence, or sensor reliability scores, etc.).

Referring to FIG. 4, in response to the correlation score that does not satisfy the single fusion condition in operation S125, the processor 120 may generate an individual fusion region for each of the first sensor region and the second sensor region and may also generate individual fusion information for each individual fusion region (S135).

One piece of fusion information of the first sensor region may be generated based on the first object information, and the other piece of fusion information of the second sensor region may be generated based on the second object information (e.g., lidar-only fusion region vs. camera-only fusion region, radar-only tracking region vs. image-only detection region, etc.).

The processor 120 may process various controls of a vehicle by using the fusion regions and pieces of fusion information generated in operations S130 and S135 (S140) (e.g., adaptive cruise control, lane-change assistance, automatic emergency braking, pedestrian warning, or autonomous steering, etc.).

According to the present disclosure, it is possible to provide a method of fusing heterogeneous sensors, of which the accuracy is increased by reflecting the characteristics of the sensors and the behavior of an object, and a vehicle (e.g., compensating for radar's poor lateral resolution, improving camera depth with lidar input, or reducing lidar sparsity using radar velocity cues, etc.).

Effects obtainable from the present disclosure are not limited to the above-described effects, and other effects that are not described will be able to be clearly understood by those skilled in the art to which the present disclosure pertains based on the following description.

While the exemplary methods of the present disclosure described above are represented as a series of operations for clarity of description, it is not intended to limit the order in which the steps are performed, and the steps may be performed simultaneously or in different order as necessary (e.g., parallel execution of overlap ratio computation and distance error evaluation, or out-of-order processing when sensor data arrives asynchronously, etc.). In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more (e.g., lidar-camera fusion only, radar-camera fusion only, or all three sensors fused together, etc.).

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc. (e.g., GPU-based parallel processing, FPGA-accelerated sensor fusion, or DSP-based error calculation, etc.).

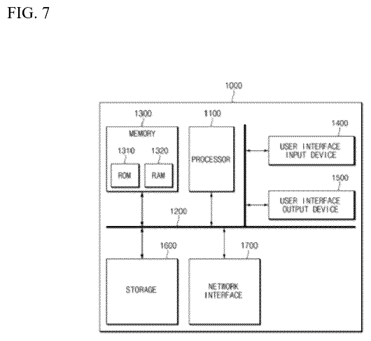

FIG. 7 shows an example computing system (e.g., a computing device of a vehicle or any other apparatus). One or more controllers, processors, etc. described herein, such as one or more components of the vehicle 100 and any other components and devices disclosed herein, may be implemented by or in the computing system as shown in FIG. 7. A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to the present disclosure, there is provided a method of fusing heterogeneous sensors, the method comprising: generating a first sensor region and a second sensor region based on first sensor data and second sensor data; generating an association region based on characteristic information of any one sensor selected from a first sensor and a second sensor; generating an association information including correlation scores based on first region information and second region information respectively corresponding to the first sensor region and the second sensor region that overlap the association region; and generating a fusion region and fusion information based on the correlation score.

According to the example of the present disclosure in the method, the characteristic information of the selected sensor may include an error attribute of the selected sensor, and the association region may be adaptively generated based on the error attribute of the selected sensor.

According to the example of the present disclosure in the method, the error attribute of the selected sensor may include at least one of a longitudinal position covariance parameter of the selected sensor and a lateral position covariance parameter of the selected sensor.

According to the example of the present disclosure in the method, the first region information may include a first position of the first sensor region, and the second region information may include a second position of the second sensor region, and the correlation score may be generated based on a distance error of the second position with respect to the first position, and the distance error is generated by reflecting an error attribute of the second sensor.

According to the example of the present disclosure in the method, wherein the first region information may further include a first area of the first sensor region, and the second region information further includes a second area of the second sensor region, and the correlation score may be generated based on the distance error, an overlap ratio between the first sensor region and the second sensor region, and an area ratio related to a ratio of an overlapping area of the first region and the second region to the first area or the second area.

According to the example of the present disclosure in the method, the distance error may be generated by reflecting the error attribute of the selected sensor and a movement direction of an object, and the object may be recognized in at least one of the first sensor region and the second sensor region.

According to the example of the present disclosure in the method, the error attribute of the selected sensor may include at least one of a longitudinal position covariance parameter of the selected sensor and a lateral position covariance parameter of the selected sensor, the movement direction of the object may include longitudinal data of the object and lateral data of the object, and the distance error may be generated by reflecting the longitudinal position covariance parameter adjusted by the longitudinal data and the lateral position covariance parameter adjusted by the lateral data.

According to the example of the present disclosure in the method, the longitudinal data of the object may be generated based on a ratio of a longitudinal velocity of the object to a lateral velocity of the object, and the lateral data of the object may be generated based on a ratio of the lateral velocity of the object to the longitudinal velocity of the object.

According to the example of the present disclosure in the method, the longitudinal data may be generated to be set within a longitudinal factor range, and the lateral data is generated to be set within a lateral factor range.

According to the example of the present disclosure in the method, the generating of the fusion region and the fusion information may include: generating a single fusion region that recognizes the first sensor region and the second sensor region as the same object and generating single fusion information about the single fusion region in response to the correlation score that satisfies a single fusion condition; and generating an individual fusion region for each of the first sensor region and the second sensor region and generating individual fusion information for each of the individual fusion regions in response to the correlation score that does not satisfy the single fusion condition.

According to another example of the present disclosure, there is provided a vehicle that implements fusion of heterogeneous sensors, the vehicle comprising: a sensor unit including a first sensor and a second sensor formed as heterogeneous sensors that detect a surrounding environment; a memory configured to store at least one instruction; and at least one processor configured to execute the at least one instruction stored in the memory. The at least one processor is configured to: generate a first sensor region and a second sensor region based on first sensor data of the first sensor and second sensor data of the second sensor; generate an association region based on characteristic information of any one sensor selected from the first sensor and the second sensor; generate an association information including correlation scores based on first region information and second region information respectively corresponding to the first sensor region and the second sensor region that overlap the association region; and generate a fusion region and fusion information based on the correlation score.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus of a vehicle, comprising:
defining a first sensor region based on first sensor data obtained from a first sensor of the vehicle, and defining a second sensor region based on second sensor data obtained from a second sensor of the vehicle, wherein the first sensor and the second sensor are heterogeneous sensors;
determining an association region based on characteristic information of at least one sensor of the first sensor or the second sensor;
generating association information comprising a correlation score, wherein the correlation score is determined based on first region information of the first sensor region and second region information of the second sensor region, and wherein the first sensor region and the second sensor region overlap the association region;
outputting, based on the association information, a signal indicating a fusion region and fusion information; and
controlling, based on the signal, autonomous driving of the vehicle.

2. The method of claim 1, wherein the characteristic information comprises an error attribute of the at least one sensor, and wherein the association region is adaptively generated based on the error attribute of the at least one sensor.

3. The method of claim 2, wherein the error attribute of the at least one sensor comprises at least one of a longitudinal position covariance parameter of the at least one sensor or a lateral position covariance parameter of the at least one sensor.

4. The method of claim 1, wherein the first region information comprises a first position of the first sensor region, and wherein the second region information comprises a second position of the second sensor region, and
wherein the generating of the association information comprises:
determining, based on an error attribute of the second sensor, a distance error of the second position with respect to the first position; and
generating, based on the distance error, the correlation score.

5. The method of claim 4, wherein the first region information comprises a first area of the first sensor region, and wherein the second region information comprises a second area of the second sensor region, and
wherein the generating of the correlation score is further based on:
a ratio of an overlapping area of the first sensor region and the second sensor region to a sum of the first area and the second area, and
a ratio of the overlapping area to the first area or the second area.

6. The method of claim 4, wherein the determining of the distance error is further based on a movement direction of an object, and wherein the object is recognized in at least one of the first sensor region and the second sensor region.

7. The method of claim 6, wherein the error attribute comprises at least one of a longitudinal position covariance parameter of the second sensor and a lateral position covariance parameter of the second sensor, and wherein the movement direction of the object is associated with longitudinal data of the object and lateral data of the object, and
wherein the determining of the distance error is further based on the longitudinal position covariance parameter and the lateral position covariance parameter, wherein the longitudinal position covariance parameter is adjusted by the longitudinal data, and wherein the lateral position covariance parameter is adjusted by the lateral data.

8. The method of claim 7, wherein the longitudinal data of the object is generated based on a ratio of a longitudinal velocity of the object to a lateral velocity of the object, and
wherein the lateral data of the object is generated based on a ratio of the lateral velocity of the object to the longitudinal velocity of the object.

9. The method of claim 7, wherein the longitudinal data of the object is configured to be within a longitudinal factor range, and wherein the lateral data of the object is configured to be within a lateral factor range.

10. The method of claim 1, wherein the outputting of the signal indicating the fusion region and the fusion information comprises:
based on the correlation score satisfying a single fusion condition, generating a single fusion region that represents the first sensor region and the second sensor region as a same object and generating single fusion information about the single fusion region; or
based on the correlation score not satisfying the single fusion condition, generating an individual fusion region for each of the first sensor region and the second sensor region and generating individual fusion information for each of the individual fusion regions.

11. A vehicle comprising:
a first sensor and a second sensor that are heterogeneous sensors configured to detect a surrounding environment of the vehicle; and
at least one processor circuit configured to:
define a first sensor region based on first sensor data obtained from the first sensor, and define a second sensor region based on second sensor data obtained from the second sensor,
determine an association region based on characteristic information of at least one sensor of the first sensor or the second sensor,
generate association information comprising a correlation score, wherein the correlation score is determined based on first region information of the first sensor region and second region information of the second sensor region, wherein the first sensor region and the second sensor region overlap the association region,
output, based on the association information, a signal indicating a fusion region and fusion information, and
control, based on the signal, autonomous driving of the vehicle.

12. The vehicle of claim 11, wherein the characteristic information comprises an error attribute of the at least one sensor, and wherein the association region is adaptively generated based on the error attribute of the at least one sensor.

13. The vehicle of claim 12, wherein the error attribute of the at least one sensor comprises at least one of a longitudinal position covariance parameter of the at least one sensor or a lateral position covariance parameter of the at least one sensor.

14. The vehicle of claim 11, wherein the first region information comprises a first position of the first sensor region, and wherein the second region information comprises a second position of the second sensor region, and wherein the at least one processor circuit is configured to:
determine, based on an error attribute of the second sensor, a distance error of the second position with respect to the first position, and
generate, based on the distance error, the correlation score.

15. The vehicle of claim 14, wherein the first region information comprises a first area of the first sensor region, and wherein the second region information comprises a second area of the second sensor region, and wherein the at least one processor circuit is configured to generate the correlation score further based on:
a ratio of an overlapping area of the first sensor region and the second sensor region to a sum of the first area and the second area, and
a ratio of the overlapping area to the first area or the second area.

16. The vehicle of claim 14, wherein the at least one processor circuit is configured to determine the distance error further based on a movement direction of an object, and wherein the object is recognized in at least one of the first sensor region and the second sensor region.

17. The vehicle of claim 16, wherein the error attribute comprises at least one of a longitudinal position covariance parameter of the second sensor and a lateral position covariance parameter of the second sensor, wherein the movement direction of the object is associated with longitudinal data of the object and lateral data of the object, and wherein the at least one processor circuit is configured to:
determine the distance error further based on the longitudinal position covariance parameter and the lateral position covariance parameter, wherein the longitudinal position covariance parameter is adjusted by the longitudinal data, and wherein the lateral position covariance parameter is adjusted by the lateral data.

18. A vehicle comprising:
a first sensor and a second sensor configured to detect a surrounding environment of the vehicle;
a driving control circuit configured to control autonomous driving of the vehicle; and
a processor circuit configured to:
define a first sensor region based on first sensor data from the first sensor, and define a second sensor region based on second sensor data from the second sensor,
determine an association region based on characteristic information of at least one sensor of the first sensor or the second sensor, wherein the characteristic information comprises an error attribute of the at least one sensor, and wherein the association region overlaps the first sensor region and the second sensor region,
generate a correlation score indicating a degree of correspondence between the first sensor region and the second sensor region based on at least one of:
the characteristic information,
region information of the first sensor region and the second sensor region, or
a movement direction of an object detected in the surrounding environment,
determine, based on the correlation score, whether the first sensor region and the second sensor region represent a same object,
output, based on the determination of whether the first sensor region and the second sensor region represent the same object, a signal indicating a fusion region and fusion information, and
control, via the driving control circuit and based on the signal, autonomous driving of the vehicle.

19. The vehicle of claim 18, wherein the processor circuit is configured to generate the correlation score by:
setting longitudinal data of the object to fall within a longitudinal factor range, and
setting lateral data of the object to fall within a lateral factor range.

20. The vehicle of claim 18, wherein the processor circuit is configured to:
based on the correlation score satisfying a fusion condition, generate a single fusion region that identifies the first sensor region and the second sensor region as the same object, and
based on the correlation score not satisfying the fusion condition, generate an individual fusion region for each of the first sensor region and the second sensor region.
